(19) United States
(12) Patent Application Publication
(10) Pub. No.: US 2025/0227606 A1
(43) Pub. Date: Jul. 10, 2025

(54) METHODS, DEVICES, AND SYSTEMS FOR PERFORMING NETWORK SLICE REPLACEMENT DURING MOBILITY

(71) Applicant: ZTE CORPORATION, Shenzhen, Guangdong (CN)

(72) Inventors: Menghan WANG, Shenzhen (CN); Shuang LIANG, Shenzhen (CN); Jinguo ZHU, Shenzhen (CN)

(21) Appl. No.: 18/705,353

(22) PCT Filed: Jan. 27, 2022
(86) PCT No.: PCT/CN2022/074298

§ 371 Date: Apr. 26, 2024

(51) Int. Cl. H04W 48/18; H04W 36/00

(52) U.S. Cl. CPC H04W 48/18; H04W 36/0011

(57) ABSTRACT

The present disclosure describes methods, system, and devices for performing network slice replacement during user equipment (UE) mobility. The method includes receiving, by a radio-access network (RAN), a list of to-be-switched protocol data unit (PDU) sessions during a handover procedure; selecting, by the RAN, a single-network slice selection assistant information (S-NSSAI) from a list of S-NSSAIs, the S-NSSAI corresponding to a PDU session in the list of to-be-switched PDU sessions; and sending, by the RAN, a message to an access and mobility management function (AMF), the message comprising the PDU session in a list of PDU sessions that require slice replacement and the S-NSSAI associated with each PDU session.

### CROSS-REFERENCE TO RELATED APPLICATION(S)

The present application is a national phase entry under 35 U.S.C 371 of International Application No. PCT/CN2022/074298, filed on Jan. 27, 2022, the entire contents of the International Patent Application are incorporated herein by reference.

### TECHNICAL FIELD

The present disclosure is directed generally to wireless communications. Particularly, the present disclosure relates to methods, devices, and systems for performing network slice replacement during user equipment (UE) mobility.

### BACKGROUND

Wireless communication technologies are moving the world toward an increasingly connected and networked society. High-speed and low-latency wireless communications rely on efficient network resource management and allocation among one or more user equipment and one or more wireless access network nodes (including but not limited to base stations). A new generation network is expected to provide high speed, low latency and ultra-reliable communication capabilities and fulfill the requirements from different industries and users.

With the rapid evolution of cellular mobile communication systems, for example in the present wireless telecommunication protocol, a handover procedure may be performed for a user equipment (UE) during UE mobility. However, under most circumstances, there may be some problems/issues associated with the handover procedure. For example, one of the problems/issues may be that, a target access network node may fail to accept one or more protocol data unit (PDU) session established on an old network slice corresponding to the PDU session, e.g., due to resource of the old network slice in the target access network node is insufficient or congested, thus resulting in poor performance of service continuity for the UE.

The present disclosure describes various embodiments for performing network slice replacement during user equipment (UE) mobility, addressing at least one of the problems/issues discussed above. The various embodiments in the present disclosure may increase efficiency and performance of service continuity for the UE, thus improving user experience and/or a technology field in the wireless communication.

### SUMMARY

This document relates to methods, systems, and devices for wireless communication, and more specifically, for performing network slice replacement during user equipment (UE) mobility.

In one embodiment, the present disclosure describes a method for wireless communication. The method includes receiving, by a radio-access network (RAN), a list of to-be-switched protocol data unit (PDU) sessions during a handover procedure; selecting, by the RAN, a single-network slice selection assistant information (S-NSSAI) from a list of S-NSSAIs, the S-NSSAI corresponding to a PDU session in the list of to-be-switched PDU sessions; and sending, by the RAN, a message to an access and mobility management function (AMF), the message comprising the PDU session in a list of PDU sessions that require slice replacement and the S-NSSAI associated with each PDU session.

In another embodiment, the present disclosure describes a method for wireless communication. The method includes receiving, by an access and mobility management function (AMF), a message from a radio-access network (RAN), the message comprising a protocol data unit (PDU) session in a list of PDU sessions that require slice replacement with a corresponding single-network slice selection assistant information (S-NSSAI) for each PDU session; determining, by the AMF, whether to accept the PDU session in the list of PDU sessions that require slice replacement with the corresponding S-NSSAI; in response to determining to accept the PDU session with the S-NSSAI, sending, by the AMF, the S-NSSAI corresponding to the PDU session to a corresponding session management function (SMF).

In another embodiment, the present disclosure describes a method for wireless communication. The method includes receiving, by a session management function (SMF), a single-network slice selection assistant information (S-NSSAI) corresponding to a protocol data unit (PDU) session in a list of PDU sessions that require slice replacement from an access and mobility management function (AMF); determining, by the SMF, whether to accept the PDU session with the S-NSSAI; in response to determining to accept the PDU session: triggering, by the SMF, replacement of a second S-NSSAI with the S-NSSAI for the PDU session, and storing, by the SMF, the S-NSSAI and the second S-NSSAI associated with a same PDU session identifier; in response to determining not to accept the PDU session: triggering, by the SMF, a PDU session release procedure; and sending, by the SMF, a N4 message to a user plane function (UPF), the N4 message comprising at least one of the following: the S-NSSAI, a network instance, or an updated rule.

In another embodiment, the present disclosure describes a method for wireless communication. The method includes receiving, by a user plane function (UPF), a N4 message from a session management function (SMF), the N4 message comprising at least one of the following: a single-network slice selection assistant information (S-NSSAI) corresponding to a protocol data unit (PDU) session in a list of PDU sessions that require slice replacement, a network instance, or an updated rule; determining, by the UPF, internal UPF resources based on the S-NSSAI or the network instance; allocating, by the UPF, core network (CN) tunnel information based on the N4 message from the SMF; and sending, by the UPF, the CN tunnel information to the SMF.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include more than one wireless access network node and one or more user equipment.

FIG. 1B shows an exemplary communication network including various terminal devices, a carrier network, data network, and service applications.

FIG. 1C shows exemplary network functions or network nodes in a communication network.

FIG. 2 shows an example of a network node.

FIG. 3 shows an example of a user equipment.

FIG. 4A shows a flow diagram of a method for wireless communication.

FIG. 4B shows a flow diagram of a method for wireless communication.

FIG. 4C shows a flow diagram of a method for wireless communication.

FIG. 4D shows a flow diagram of a method for wireless communication.

FIG. 5 shows a schematic diagram of an exemplary embodiment for wireless communication.

FIG. 6 shows a schematic diagram of an exemplary embodiment for wireless communication.

FIG. 7 shows a schematic diagram of an exemplary embodiment for wireless communication.

FIG. 8 shows a schematic diagram of an exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various methods and devices for performing network slice replacement during user equipment (UE) mobility.

Wireless communication technologies are moving the world toward an increasingly connected and networked society. High-speed and low-latency wireless communications rely on efficient network resource management and allocation among one or more user equipment and one or more wireless access network nodes (including but not limited to base stations). A new generation network is expected to provide high speed, low latency and ultra-reliable communication capabilities and fulfill the requirements from different industries and users.

With the rapid evolution of cellular mobile communication systems, for example in the present wireless telecommunication protocol, a handover procedure may be performed for a user equipment (UE) during UE mobility. However, under most circumstances, there may be some problems/issues associated with the handover procedure. For example, one of the problems/issues may be that, a target radio access network (RAN) node may fail to accept one or more protocol data unit (PDU) session established on an old network slice corresponding to the PDU session, e.g., due to resource of the old network slice in the target access network node is insufficient or congested, thus resulting in poor performance of service continuity for the UE.

The present disclosure describes various embodiments for performing network slice replacement during user equipment (UE) mobility, so as to support network slice service continuity during UE mobility in some scenarios wherein resource may be limited for the network slice in the target RAN node. The UE may have established PDU session(s) with a single-network slice selection assistant information (S-NSSAI). During UE mobility, a inter RAN handover from a source RAN to a target RAN may be performed for the UE. The S-NSSAI may be supported by both the source RAN node and the target RAN node, but the target RAN node may fail to accept the PDU session(s) established on the S-NSSAI, for example but not limited to, due to the resource of the S-NSSAI in the target RAN node is insufficient or congested. In some implementations, the PDU session(s) with the S-NSSAI may be rejected by the target RAN node, resulting in a bad service continuity for the UE. The present disclosure describes various embodiments for performing network slice replacement during user equipment (UE) mobility, at least addressing the above issue/problem. The present disclosure provides various embodiments to support service continuity when the network slice resource is insufficient in the target RAN node during inter RAN handover procedure.

In various embodiments in the present disclosure, a radio access network (RAN) may refer to a new generation radio access network (NG-RAN); and in various embodiments, “RAN” and “NG-RAN” may be used interchangeably. In the present disclosure, a network slice may refer to a logical network that provides specific network capabilities and network characteristics; and/or a network slice instance may refer to a set of network function instances and the required resources (e.g., compute, storage and networking resources) which form a deployed network slice.

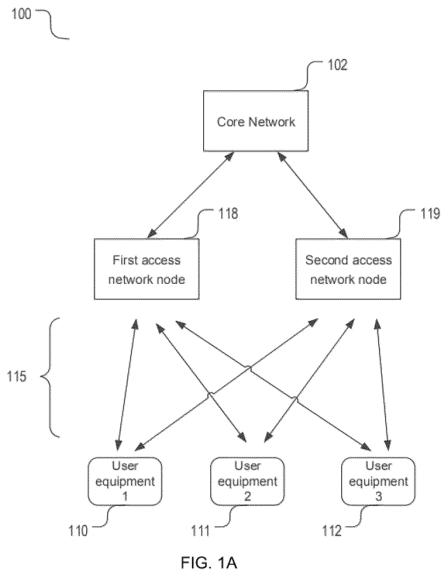

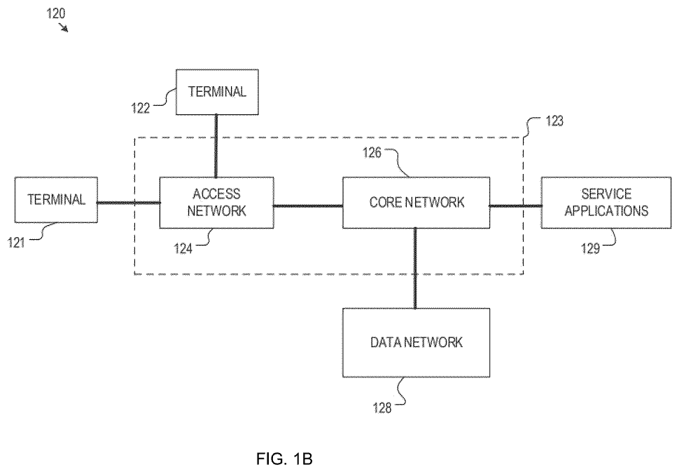

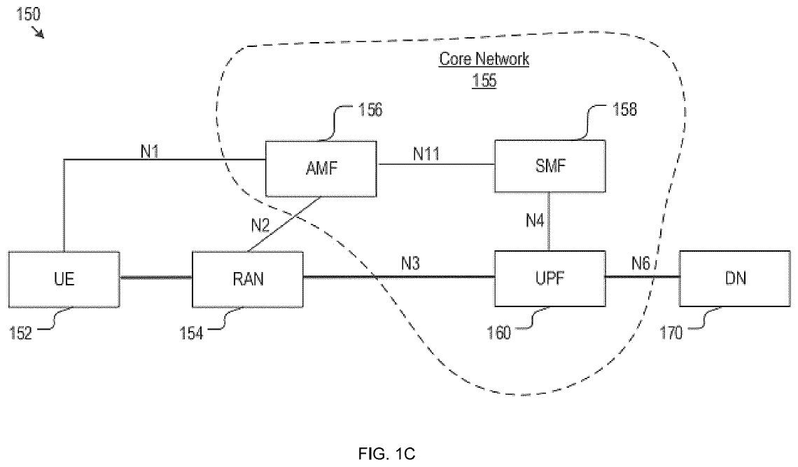

FIG. 1A shows a wireless communication system 100 including a portion or all of the following: a core network (CN, 102), one or more access network node (or radio access network (RAN)) 118 and 119, and/or one or more user equipment (UE) (110, 111, and 112).

The core network (102) may communicate with the one or more access network node (118 and/or 119). The UE may connect to one network node 118, for example, a radio access network (RAN) node (118 or 119) and/or a core network (CN) node (102). The wireless network node (118 and 119) may include a network base station, which may be a nodeB (NB, e.g., a gNB) in a mobile telecommunications context. Each of the UE (110, 111, and/or 112) may wirelessly communicate with the wireless network node (118 and/or 119) via one or more radio channels 115. For example, the first UE 110 may wirelessly communicate with the first network node 118 via a channel including a plurality of radio channels during a certain period of time; during another period of time, the first UE 110 may wirelessly communicate with the second network node 119 via a channel including a plurality of radio channels.

An exemplary communication network in various embodiments, shown as 120 in FIG. 1B, may include a portion or all of the following: terminal devices 121 and 122, a carrier network 123, various service applications 129, and other data networks 128. The carrier network 123, for example, may include access networks (or radio access network (RAN) 124) and a core network 126. The carrier network 123 may be configured to transmit voice, data, and other information (collectively referred to as data traffic) among terminal devices 121 and 122, between the terminal devices and the service applications 129, and/or between the terminal devices and the other data networks 128. Communication sessions and corresponding data paths may be established and configured for such data transmission. The access networks 124 may be configured to provide terminal devices network access to the core network 126. The access network may, for example, support wireless access via radio resources, or wireline access. The core network may include various network nodes or network functions configured to control the communication sessions and perform network access management and data traffic routing. The service applications may be hosted by various application servers that are accessible by the terminal devices through the core network of the carrier network. A service application 129 may be deployed as a data network outside of the core network. Likewise, the other data networks 128 may be accessible by the terminal devices through the core network 126 and may appear as either data destination or data source of a particular communication session instantiated in the carrier network 123.

The core network 126 of FIG. 1B may include various network nodes or functions geographically distributed and interconnected to provide network coverage of a service region of the carrier network 123. These network nodes or functions may be implemented as dedicated hardware network elements. Alternatively, these network nodes or functions may be virtualized and implemented as virtual machines or as software entities. A network node may each be configured with one or more types of network functions. These network nodes or network functions may collectively provide the provisioning and routing functionalities of the core network 126. The term “network nodes” and “network functions” are used interchangeably in this disclosure.

FIG. 1C further shows an exemplary architecture of a 5G system (5GS), which also shows an exemplary division of network functions (NFs) in a core network of a communication network 150. While only single instances of network nodes or network functions are illustrated in FIG. 1C, those having ordinary skill in the art readily understand that each of these network nodes may be instantiated as multiple instances of network nodes that are distributed throughout the core network.

As shown in FIG. 1C, the 5GS may include at least one UE (152), at least one RAN (154), at least one core network (155), and/or at least one data network (DN, 170). The core network may include, but is not limited to, a portion or all of the following: at least one access and mobility management function (AMF), at least one session management function (SMF), and/or at least one user plane function (UPF). Exemplary signaling and data exchange between the various types of network nodes/functions through various communication interfaces are indicated by the various connection lines in FIG. 1C. Such signaling and data exchange may be carried by signaling or data messages following predetermined formats or protocols.

Referring to the at least one RAN (154), during UE mobility, inter-NG-RAN handover procedure may be initiated to hand over the UE from a source NG-RAN (Source NG-RAN) to a target NG-RAN (Target NG-RAN).

Referring to the AMF (156), this network function (NF) may include functionalities such as UE Mobility Management, Reachability Management, Connection Management and Registration Management. The AMF terminates the RAN control plane (CP) interface N2 and non-access stratum (NAS) interface N1, NAS ciphering and integrity protection. It also transparently transmits N2 SM information between the RAN and the SMF.

Referring to the SMF (158), this NF includes the following functionalities: session establishment, modification and release, UE IP address allocation & management, selection and control of user plane (UP) function, etc.

Referring to the UPF (160), this NF serves as an anchor point for intra-/inter-radio access technology (RAT) mobility and as the external PDU session point of interconnect to the data network (DN). The UPF also routes and forwards the data packet according to the indication from the SMF. It also buffers the downlink (DL) data when the UE is in idle mode. The UPF may receive uplink user plane traffic from the RAN and transmits downlink user plane traffic to the RAN via an N3 interface.

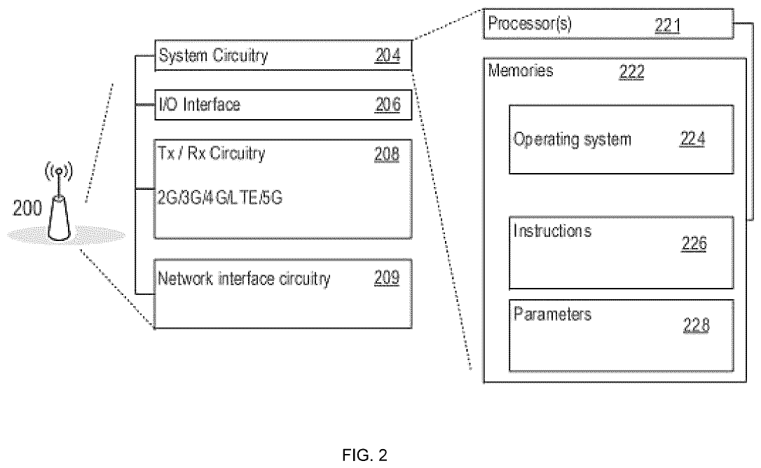

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

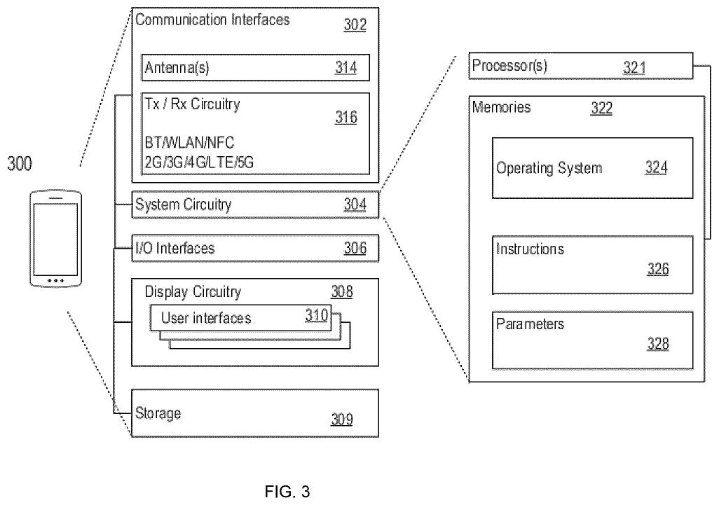

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G, 6G, any further telecommunication generation, and/or any future generation wireless communication standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, any further telecommunication generation, or other data that the UE 300 will send, or has received, through the communication interfaces 302. In various implementations, a system power for the UE 300 may be supplied by a power storage device, such as a battery or a transformer.

The present disclosure describes various embodiments, which may be implemented, partly or totally, on the network base station and/or the user equipment described above in FIGS. 2-3.

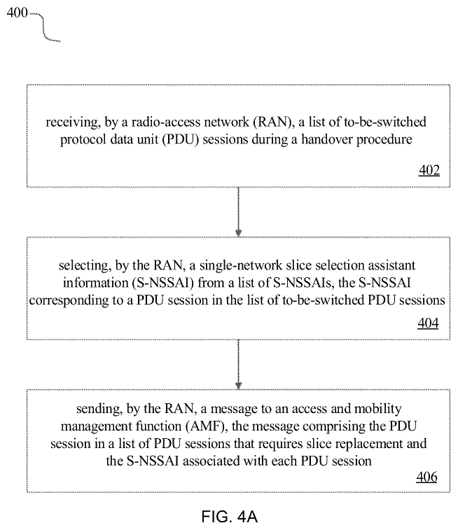

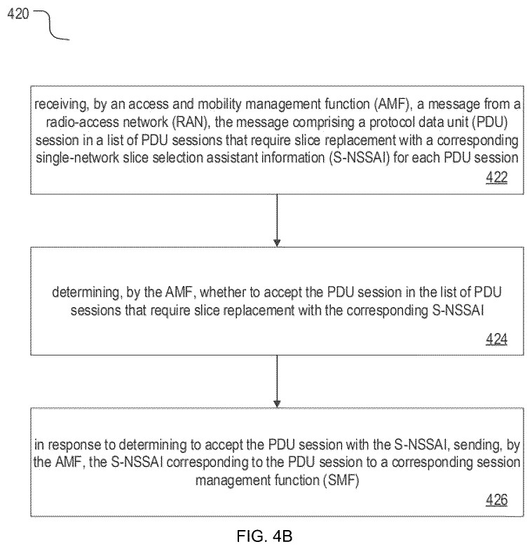

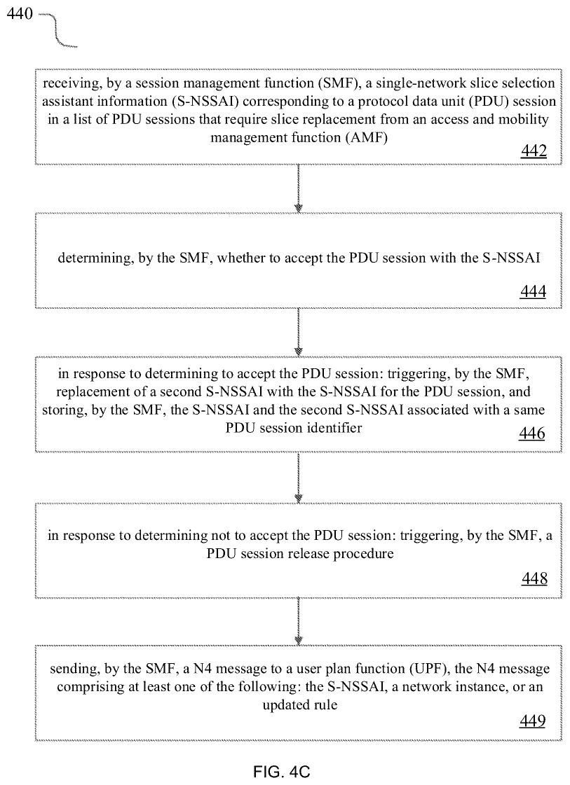

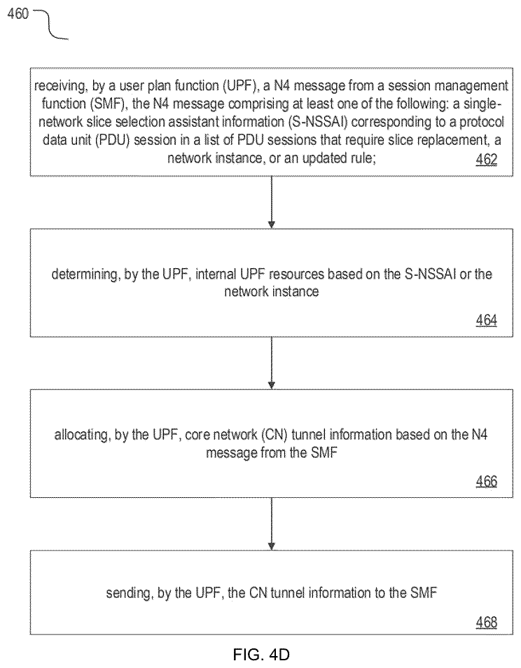

Referring to FIG. 4A, the present disclosure describes various embodiments of a method 400 for wireless communication. The method 400 may include a portion or all of the following steps: step 402, receiving, by a radio-access network (RAN), a list of to-be-switched protocol data unit (PDU) sessions during a handover procedure; step 404, selecting, by the RAN, a single-network slice selection assistant information (S-NSSAI) from a list of S-NSSAIs, the S-NSSAI corresponding to a PDU session in the list of to-be-switched PDU sessions; and/or step 406, sending, by the RAN, a message to an access and mobility management function (AMF), the message comprising the PDU session in a list of PDU sessions that require slice replacement and the S-NSSAI associated with each PDU session. In some implementations, the RAN may refer to a target NG-RAN; and/or the S-NSSAI may refer to a backup S-NSSAI.

In some other implementations, the RAN receives the list of to-be-switched PDU sessions from one of a second RAN or the AMF. The second RAN may refer to a source NG-RAN.

In some other implementations, the S-NSSAI is configured to replace a second S-NSSAI, the second S-NSSAI corresponding to the PDU session in the list of to-be-switched PDU sessions prior to the handover procedure. The second S-NSSAI may refer to an old S-NSSAI.

In some other implementations, the RAN selects the S-NSSAI from the list of S-NSSAIs; and the list of S-NSSAIs comprises one or more S-NSSAI that is allowed to use for a user equipment (UE).

In some other implementations, in response to the RAN's failure of accepting the PDU session in the list of to-be-switched PDU sessions associated with the second S-NSSAI, the RAN selects the S-NSSAI from the list of S-NSSAIs and replace the second S-NSSAI with the selected S-NSSAI for the PDU session.

In some other implementations, the message comprises one of the following: the list of to-be-switched PDU sessions comprising the list of PDU sessions that require slice replacement; the list of PDU sessions that require slice replacement; the list of to-be-switched PDU sessions comprising the list of PDU sessions that require slice replacement and a list of fail-to-establish PDU sessions comprising the list of PDU sessions that require slice replacement; or the list of PDU sessions that require slice replacement and the list of fail-to-establish PDU sessions comprising the list of PDU sessions that require slice replacement.

In some other implementations, for each PDU session in the list of PDU sessions that require slice replacement, the message comprises the corresponding S-NSSAI, a PDU session identifier (ID), and N2 session management (SM) information corresponding to the each PDU session; and the N2 SM information comprises access network (AN) tunnel information.

In some other implementations, the method 400 may optionally further include receiving, by the RAN, an updated CN tunnel information or an updated QoS profile for one or more PDU sessions in the list of PDU sessions that require slice replacement.

Referring to FIG. 4B, the present disclosure describes various embodiments of a method 420 for wireless communication. The method 420 may include a portion or all of the following steps: step 422, receiving, by an access and mobility management function (AMF), a message from a radio-access network (RAN), the message comprising a protocol data unit (PDU) session in a list of PDU sessions that require slice replacement with a corresponding single-network slice selection assistant information (S-NSSAI) for each PDU session; step 424, determining, by the AMF, whether to accept the PDU session in the list of PDU sessions that require slice replacement with the corresponding S-NSSAI; and/or step 426, in response to determining to accept the PDU session with the S-NSSAI, sending, by the AMF, the S-NSSAI corresponding to the PDU session to a corresponding session management function (SMF). In some implementations, the RAN may refer to a target NG-RAN; and/or the S-NSSAI may refer to a backup S-NSSAI.

In some other implementations, the S-NSSAI is configured to replace a second S-NSSAI, the second S-NSSAI corresponding to the PDU session that requires slice replacement prior to a handover procedure. The second S-NSSAI may refer to an old S-NSSAI.

In some other implementations, the step 424 may alternatively include determining, by the AMF, whether the S-NSSAI and the second S-NSSAI are supported by a same SMF; in response to determining that the S-NSSAI and the second S-NSSAI are supported by the same SMF, determining, by the AMF, to accept the PDU session; or in response to determining that the S-NSSAI and the second S-NSSAI are not supported by the same SMF, determining, by the AMF, not to accept the PDU session.

In some other implementations, the method 420 may optionally further include, in response to determining to accept the PDU session: sending, by the AMF, corresponding N2 SM information and the corresponding S-NSSAI to the corresponding SMF, in response to receiving the PDU session in a list of fail-to-establish PDU sessions, discarding, by the AMF, the PDU session in the list of fail-to-establish PDU sessions, and/or storing, by the AMF, the S-NSSAI and the second S-NSSAI corresponding to a same PDU session identifier.

In some other implementations, the method 420 may optionally further include, in response to determining not to accept the PDU session: discarding, by the AMF, the PDU session in a list of to-be-switched PDU sessions or the list of PDU sessions that require slice replacement, in response to receiving the PDU session in a list of fail-to-establish PDU sessions, sending, by the AMF, corresponding N2 SM information to the corresponding SMF, and/or in response to receiving the list of fail-to-establish PDU sessions not comprising the PDU session, sending, by the AMF, information to release the PDU session to the corresponding SMF and include the PDU session in the list of fail-to-establish PDU sessions.

Referring to FIG. 4C, the present disclosure describes various embodiments of a method 440 for wireless communication. The method 440 may include a portion or all of the following steps: step 442, receiving, by a session management function (SMF), a single-network slice selection assistant information (S-NSSAI) corresponding to a protocol data unit (PDU) session in a list of PDU sessions that require slice replacement from an access and mobility management function (AMF); step 444, determining, by the SMF, whether to accept the PDU session with the S-NSSAI; step 446, in response to determining to accept the PDU session: triggering, by the SMF, replacement of a second S-NSSAI with the S-NSSAI for the PDU session, and storing, by the SMF, the S-NSSAI and the second S-NSSAI associated with a same PDU session identifier; step 448, in response to determining not to accept the PDU session: triggering, by the SMF, a PDU session release procedure; and step 449, sending, by the SMF, a N4 message to a user plane function (UPF), the N4 message comprising at least one of the following: the S-NSSAI, a network instance, or an updated rule. In some implementations, the S-NSSAI may refer to a backup S-NSSAI.

In some implementations, the S-NSSAI is configured to replace the second S-NSSAI, the second S-NSSAI corresponding to the PDU session prior to a handover procedure. The second S-NSSAI may refer to an old S-NSSAI.

In some other implementations, the method 440 may optionally further include a portion or all of the following: receiving, by the SMF, CN tunnel information from the UPF; and/or in response to the CN tunnel information or a QoS profile being updated, sending, by the SMF, the updated CN tunnel information or the updated QoS profile to a radio-access network (RAN).

Referring to FIG. 4D, the present disclosure describes various embodiments of a method 460 for wireless communication. The method 460 may include a portion or all of the following steps: step 462, receiving, by a user plane function (UPF), a N4 message from a session management function (SMF), the N4 message comprising at least one of the following: a single-network slice selection assistant information (S-NSSAI) corresponding to a protocol data unit (PDU) session in a list of PDU sessions that require slice replacement, a network instance, or an updated rule; step 464, determining, by the UPF, internal UPF resources based on the S-NSSAI or the network instance; step 466, allocating, by the UPF, core network (CN) tunnel information based on the N4 message from the SMF; and step 468, sending, by the UPF, the CN tunnel information to the SMF. In some implementations, the S-NSSAI may refer to a backup S-NSSAI.

In some other implementations, the S-NSSAI is configured to replace a second S-NSSAI, the second S-NSSAI corresponding to the PDU session prior to a handover procedure. The second S-NSSAI may refer to an old S-NSSAI.

Below, the present disclosure describes various exemplary embodiments in more details, which should be regarded as examples only, and do not impose any limitation on various embodiments in the present disclosure. Any portion (e.g., one or more step) of a single embodiment or a plurality of embodiments may be combined or arranged in any amount or in any order, as desired. In some embodiments, one or more steps may be performed in parallel, as desired.

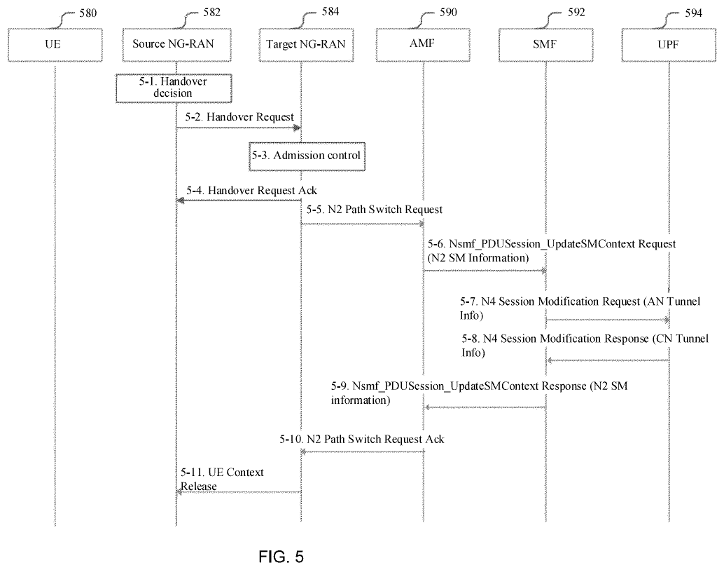

FIG. 5 shows a schematic diagram of an exemplary embodiment for an Xn based inter NG-RAN handover procedure, including a portion or all of the following: a UE 580, a source NG-RAN 582, a target NG-RAN 584, an AMF 590, an SMF 592, and/or an UPF 594.

Referring to step 5-1, the source NG-RAN decides to handover the UE based on related information, e.g., due to new radio conditions, load balancing or specific service.

Referring to step 5-2, the source NG-RAN issues a Handover Request message to the target NG-RAN with necessary information to prepare the handover at the target side. The information includes at least the target cell ID, the current QoS flow to data radio bearer (DRB) mapping rules applied to the UE, PDU session related information and etc. The PDU session related information includes the slice information and QoS flow level QoS profile(s), to setup resources for the PDU Session(s) of the UE in the target NG-RAN.

Referring to step 5-3, an admission control may be performed by the target NG-RAN. A slice-aware admission control may be performed when the slice information is sent to the target NG-RAN. When the PDU sessions are associated with non-supported slices or the slices are congested or the resource of the slices is insufficient, the target NG-RAN may reject such PDU sessions.

Referring to step 5-4, the target NG-RAN prepares the handover and sends the HANDOVER REQUEST ACKNOWLEDGE to the source NG-RAN, in which it indicates the list of PDU sessions and QoS flows for which it has accepted.

Referring to step 5-5, an N2 path switch request message may be sent by the target NG-RAN to the AMF. The N2 path switch request message may include a portion or all of the following: a list of PDU sessions to be switched with corresponding N2 SM Information, and/or a list of PDU sessions that failed to be established with the corresponding failure cause given in the N2 SM information.

The Target NG-RAN sends N2 Path Switch Request message to AMF to inform that the UE has moved to a new target cell and provides a List Of PDU Sessions To Be Switched. AN Tunnel Info for each PDU Session to be switched is included in the corresponding N2 SM Information.

The target NG-RAN may include the PDU session in the PDU sessions rejected list in response to at least one of the following conditions: when none of the QoS flows of a PDU session is accepted by the target NG-RAN; or when the corresponding network slice is not supported in the target NG-RAN.

For the PDU sessions to be switched to the target NG-RAN, the N2 Path Switch Request message may include the list of accepted QoS Flows.

Referring to step 5-6, a Nsmf_PDUSession_UpdateSMContext request message may be sent by the AMF to the SMF. The Nsmf_PDUSession_UpdateSMContext request message may include N2 session management (SM) information received from the target NG-RAN.

The AMF sends the N2 SM information to corresponding the SMF by invoking the Nsmf_PDUSession_UpdateSMContext request service operation for each PDU session in the lists of PDU sessions received in the N2 path switch request message. The request message contains either an indication that the PDU session is to be switched (e.g., together with information on the N3 addressing to use and on the transferred QoS flows incorporated in the N2 SM information) or an indication that the PDU session is to Be rejected (e.g., together with corresponding rejection cause incorporated in the N2 SM information).

When a PDU session is rejected by the target NG-RAN with an indication that the PDU session was rejected because User Plane Security Enforcement is not supported in the target NG-RAN and the user plane enforcement policy indicates as “Required”, the SMF triggers the release of this PDU session. In all other cases of PDU session rejection, the SMF may decide whether to release the PDU session or to deactivate the UP connection of this PDU session.

When some of the QoS Flows of a PDU session are not accepted by the target NG-RAN, the SMF may initiate the PDU session modification procedure to remove the non-accepted QoS flows from the PDU session(s) after the handover procedure is completed.

For the PDU session(s) that do not have active N3 UP connections before handover procedure, the SMF(s) may keep the inactive status after the handover procedure.

Referring to step 5-7, an N4 session modification request message may be sent by the SMF to the UPF. The N4 session modification request message may include an access network (AN) tunnel information.

For one or more PDU sessions that are modified by the target NG-RAN, the SMF sends an N4 session modification request message to the UPF. Depending on the network deployment, the core network (CN) tunnel information of the UPF used for connection to the target NG-RAN and connection to the source NG-RAN may be different, e.g., due to that the source and target NG-RAN are in different IP domains. In this case the SMF may ask the UPF to allocate new CN tunnel information by providing the target network instance in the request message.

Referring to step 5-8, an N4 session modification response message may be sent from the UPF to the SMF. The N4 session modification response message may include a CN tunnel information.

For the PDU sessions that are switched, the UPF returns an N4 session modification response message to the SMF after requested PDU sessions are switched. Only for PDU sessions whose user plane resources are not being released and were requested by the SMF, tunnel identifiers for uplink traffic are included. For the PDU sessions that are deactivated, the UPF returns an N4 session modification response message to the SMF after the N3 (R) AN tunnel information is released.

Referring to step 5-9, a Nsmf_PDUSession_UpdateSMContext response message may be sent by the SMF to the AMF. The Nsmf_PDUSession_UpdateSMContext response message may include a N2 SM information.

For PDU sessions which have been switched successfully, the N2 SM information includes CN tunnel information, updated parameters for the accepted QoS flows. The CN tunnel information of the UPF sent to the AMF is used to setup N3 tunnel.

For PDU sessions which have not been switched successfully, the N2 SM information includes corresponding failure cause. The SMF releases the PDU sessions which have failed to be switched using the SMF initiated PDU session release procedure.

Referring to step 5-10, a N2 path switch request acknowledge message may be sent by the AMF to the target NG-RAN. The N2 path switch request acknowledge message may include N2 SM information.

For PDU sessions which have been switched successfully, the N2 SM information includes CN tunnel information, updated parameters for the accepted QoS flows.

For PDU sessions which have not been switched successfully, the N2 SM information includes corresponding failure cause.

If none of the requested PDU sessions have been switched successfully, the AMF may send an N2 path switch request failure message to the target NG-RAN.

Referring to step 5-11, upon reception of the N2 path switch request acknowledge message from the AMF, the target NG-RAN may send the UE a context release message to inform the source NG-RAN about the success of the handover and triggers the release of resources at the source NG-RAN node.

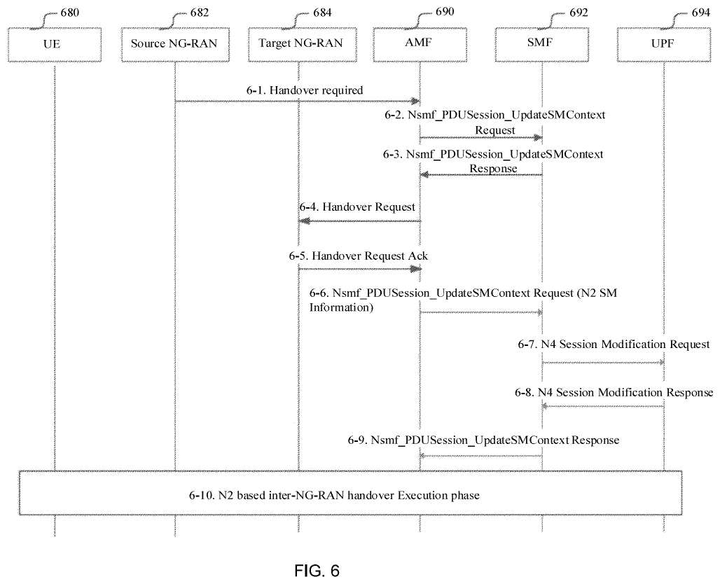

FIG. 6 shows a schematic diagram of an exemplary embodiment for a N2 based inter NG-RAN handover procedure, including a portion or all of the following: a UE 680, a source NG-RAN 682, a target NG-RAN 684, an AMF 690, an SMF 692, and/or an UPF 694.

Referring to step 6-1, a handover required message may be sent by the source NG-RAN to the AMF. The handover required message may include a portion or all of the following: a source to target transparent container, N2 SM information list, one or more PDU session identifiers (IDs).

The source to target transparent container includes NG-RAN information created by the source NG-RAN (S-RAN) to be used by the target NG-RAN (T-RAN), and is transparent to the 5GC.

All PDU sessions handled by the S-RAN (i.e. all existing PDU Sessions with active user plane (UP) connections) may be included in the handover required message, indicating which of those PDU session(s) are requested by the S-RAN to handover.

Referring to step 6-2, a Nsmf_PDUSession_UpdateSMContext request message may be sent by the AMF to the SMF. The Nsmf_PDUSession_UpdateSMContext request message may include at least one of the following: a PDU session ID, and/or N2 SM information.

For each PDU session indicated by the S-RAN, the AMF invokes the Nsmf_PDUSession_UpdateSMContext request to the associated SMF. However, when the S-NSSAI associated with the PDU session is not available in the AMF, the AMF does not invoke Nsmf_PDUSession_UpdateSMContext request for this PDU Session.

Referring to step 6-3, a Nsmf_PDUSession_UpdateSMContext response message may be sent by the SMF to the AMF. The Nsmf_PDUSession_UpdateSMContext response message may include at least one of the following: a PDU Session ID, N2 SM information, and/or a reason for non-acceptance.

When a N2 handover for the PDU session is accepted, the SMF includes, in the response message, the N2 SM information containing the N3 UP address and the uplink (UL) CN tunnel ID of the UPF and the QoS parameters.

When a N2 handover for the PDU session is not accepted, the SMF does not include, in the response message, N2 SM information regarding the PDU session to avoid establishment of radio resources at the target NG-RAN. Instead of that, the SMF provides a reason for non-acceptance.

Referring to step 6-4, a handover request message may be sent by the AMF to the target NG-RAN. The handover request message may include at least one of the following: a source to target transparent container, N2 mobility management (MM) information, a N2 SM information list.

The source to target transparent container is forwarded as received from the S-RAN. The N2 MM information includes, e.g., security information and a mobility restriction list when available in the AMF.

The N2 SM information list includes N2 SM information received from one or more SMF for the T-RAN in the Nsmf_PDUSession_UpdateSMContext response messages received.

Referring to step 6-5, a handover request acknowledge message may be sent by the target NG-RAN to the AMF. The handover request acknowledge message may include at least one of the following: a target to source transparent container, a list of PDU sessions to handover with corresponding N2 SM information, and/or a list of PDU sessions that failed to be established with the failure cause given in the corresponding N2 SM information.

The T-RAN creates a list Of PDU sessions failed to be setup and reason for failure (e.g., a T-RAN decision, S-NSSAI being unavailable, S-NSSAI being congested or the resource of the S-NSSAI being insufficient, unable to fulfil user plane security enforcement) based on the T-RAN determination. The information is provided to the S-RAN.

The N2 SM information in the list Of PDU sessions to handover, contains per PDU session ID T-RAN N3 addressing information i.e. N3 UP address and tunnel ID of the T-RAN for the PDU session.

Referring to step 6-6, a Nsmf_PDUSession_UpdateSMContext request message may be sent by the AMF to the SMF. The Nsmf_PDUSession_UpdateSMContext request message may include at least one of the following: a PDU session ID, and/or N2 SM information received from the T-RAN.

For each N2 SM information received from the T-RAN (N2 SM information included in the handover request acknowledge message), the AMF sends the received N2 SM information to the SMF indicated by the respective PDU session ID.

When no new UPF is selected, the SMF stores the N3 tunnel information of the T-RAN from the N2 SM information when a N2 handover is accepted by the T-RAN.

When a PDU session is indicated as a rejected PDU session by the target NG-RAN with an indication that the PDU session was rejected because user plane security enforcement is not supported in the target NG-RAN and the user plane enforcement policy indicates “Required”, the SMF triggers the release of this PDU session. In all other cases of PDU session rejection, the SMF may decide whether to release the PDU session (possibly triggering the re-establishment of the PDU session) or to deactivate the UP connection of this PDU session.

When some of the QoS flows of a PDU session are not accepted by the target NG-RAN, the SMF may initiate the PDU session modification procedure to remove the non-accepted QoS flows from the PDU session(s) after the handover procedure is completed.

Referring to step 6-7, a N4 session modification request message may be sent by the SMF to the UPF.

When the UPF is not re-allocated, this message may include the T-RAN SM N3 forwarding information list.

Referring to step 6-8, a N4 session modification response message may be sent by the UPF to the SMF.

The UPF allocates tunnel information and returns an N4 session establishment response message to the SMF. The UPF SM N3 forwarding information list includes a UPF N3 address, one or more UPF N3 tunnel identifiers for downlink (DL) data forwarding.

Referring to step 6-9, a Nsmf_PDUSession_UpdateSMContext response message may be sent by the SMF to the AMF. The Nsmf_PDUSession_UpdateSMContext response message may include N2 SM Information.

The SMF sends a Nsmf_PDUSession_UpdateSMContext Response message per PDU session to the AMF.

The SMF creates a N2 SM information containing the DL forwarding tunnel information to be sent to the S-RAN by the AMF.

Referring to step 6-10, a N2 based inter NG-RAN handover execution phase may be performed.

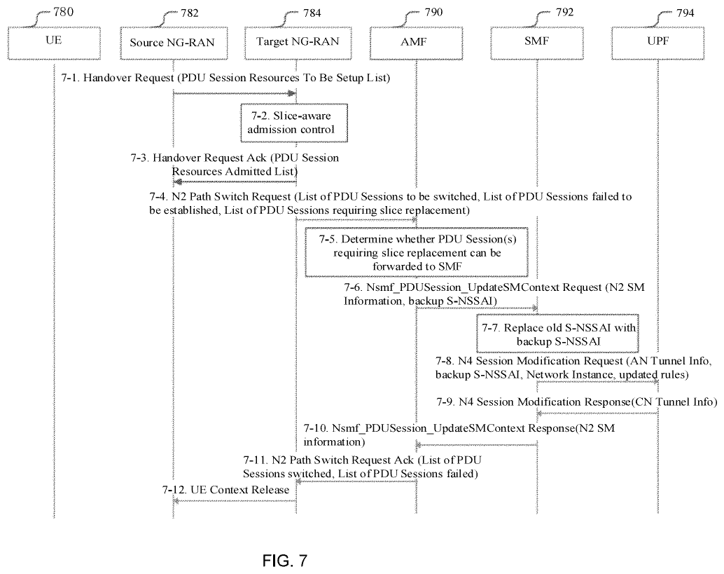

FIG. 7 shows a schematic diagram of an exemplary embodiment for a network slice replacement during an Xn based inter-NG-RAN handover procedure, including a portion or all of the following: a UE 780, a source NG-RAN 782, a target NG-RAN 784, an AMF 790, an SMF 792, and/or an UPF 794. During an Xn based inter NG-RAN handover procedure, when the PDU Session is associated with network slice which is congested at the target NG-RAN or the resource of the network slice is insufficient, a slice replacement may be realized, so that the network slice service continuity is guaranteed during UE mobility.

Referring to step 7-1, the source NG-RAN may issue a handover request message to the target NG-RAN to prepare the handover at the target side. The request message includes PDU session resources to be setup list, to setup resources for the PDU session(s) of the UE in the target NG-RAN. For each PDU session, it includes the slice information and QoS flow level QoS profile(s).

Referring to step 7-2, a slice-aware admission control may be performed by the target NG-RAN. The target NG-RAN fails to accept PDU Session(s) established on one or more S-NSSAIs for the UE due to, e.g., the resource of the S-NSSAI(s) in the target NG-RAN node is insufficient or congested. Instead of rejecting such PDU Session(s), the target NG-RAN selects a backup S-NSSAI from the allowed NSSAI, e.g., based on local configuration, to replace the old S-NSSAI with the selected backup S-NSSAI for PDU Session(s) established on the old S-NSSAI. When the backup S-NSSAI is selected for the old S-NSSAI, the target NG-RAN accepts the PDU Session(s) with slice replacement from old S-NSSAI to selected backup S-NSSAI.

Referring to step 7-3, the target NG-RAN may send the handover request acknowledge message to the source NG-RAN. The message includes PDU session resources admitted list, in which it indicates the list of PDU sessions and QoS flows for which it has accepted.

Referring to step 7-4, the target NG-RAN sends an N2 path switch request message to the AMF to inform that the UE has moved to a new target cell.

The message may include a list of PDU sessions to be switched, with a PDU Session ID and corresponding N2 SM information for each PDU session. The corresponding N2 SM information includes AN tunnel information. The message may also include a list of PDU sessions that failed to be established, with a PDU Session ID and corresponding N2 SM information for each PDU session. The corresponding N2 SM information includes the failure cause.

The message may also include the accepted PDU session(s) with slice replacement in one of the following alternative methods.

In one method, the PDU session(s) is included in the list of PDU sessions to be switched, with a PDU session ID, a backup S-NSSAI, and the corresponding N2 SM information for each of these PDU sessions. The corresponding N2 SM information includes AN tunnel information. In this method, the list of PDU sessions to be switched may already exist, but it is expanded to include the backup S-NSSAI for the PDU session when available.

In another method, a list of PDU sessions that requires slice replacement is included in the message, with a PDU session ID, a backup S-NSSAI, and corresponding N2 SM information for each PDU Session. The corresponding N2 SM information includes AN tunnel information, similar as the N2 SM information in PDU session resource admitted list. In this method, the list of PDU sessions that requires slice replacement may be a newly defined information element.

In another method, the PDU session(s) may be included in the list of PDU sessions to be switched, with a PDU session ID, a backup S-NSSAI, and the corresponding N2 SM information for each of these PDU sessions. The corresponding N2 SM information includes AN tunnel information. The PDU session(s) is also included in the list of PDU sessions that failed to be established.

In another method, a list of PDU sessions that requires slice replacement is included in the message, with a PDU session ID, a backup S-NSSAI, and corresponding N2 SM information for each PDU session. The corresponding N2 SM information includes AN tunnel information, similar as the N2 SM information in PDU session resource admitted list. The PDU session(s) is also included in the list of PDU sessions that failed to be established.

Referring to step 7-5, the AMF may determine whether the PDU session(s) that requires slice replacement may be forwarded to the corresponding SMF. When the PDU session(s) that requires slice replacement can be forwarded, e.g., the old S-NSSAI and the backup S-NSSAI can be supported by the same SMF, the AMF forwards the N2 SM information and the backup S-NSSAI of the PDU session to the corresponding SMF. The AMF discards the items for such PDU sessions in the list of PDU sessions that failed to be established, when received. The AMF stores both the old S-NSSAI and the backup S-NSSAI associated with the same PDU session identifier.

When the PDU session(s) that requires slice replacement cannot be forwarded, e.g., the old S-NSSAI and the backup S-NSSAI cannot be supported by the same SMF, the AMF discards the items for such PDU sessions in the list of PDU sessions to be switched or list of PDU sessions that requires slice replacement. When the list of PDU sessions that failed to be established includes the PDU session(s) that requires slice replacement, the AMF forwards the N2 SM information of the PDU session to the corresponding SMF. Otherwise the AMF informs the SMF to release such PDU session(s) and include such PDU session(s) in the list of failed PDU sessions.

Referring to step 7-6, the AMF sends Nsmf_PDUSession_UpdateSMContext request message to the SMF for each PDU session in the lists of PDU sessions received in the N2 path switch request. The message includes the N2 SM information and the backup S-NSSAI, when received.

Referring to step 7-7, when the SMF receives the backup S-NSSAI for the PDU Session and SMF decides to accept the replacement, the SMF triggers replacement of old S-NSSAI with the backup S-NSSAI for the PDU session. The SMF stores both the old S-NSSAI and the backup S-NSSAI associated with the same PDU session identifier. When the SMF cannot accept the replacement, the SMF triggers the N4 session release procedure.

Referring to step 7-8, the SMF may send a N4 session modification request message to the UPF. The message may include the backup S-NSSAI, the network instance (e.g., selected based on the backup S-NSSAI), the updated rules such as packet detection rule (PDR) and QoS enforcement rule (QER) (e.g., taking the backup S-NSSAI into consideration). The UPF may use the parameters, e.g., the backup S-NSSAI and the network instance, to determine internal UPF resources. Depending on the network deployment, the CN tunnel information of UPF used for the old S-NSSAI and the backup S-NSSAI may be different. In this case, the SMF may ask the UPF to allocate new CN tunnel information.

When the UPF cannot support both the old S-NSSAI and the backup S-NSSAI, a new UPF supporting both S-NSSAIs may be selected. When the new UPF is selected, the SMF sends a N4 session establishment request message to the UPF with the similar parameters.

Referring to step 7-9, the UPF returns an N4 session modification/establishment response message to the SMF with updated CN tunnel information when available.

Referring to step 7-10, the SMF sends an Nsmf_PDUSession_UpdateSMContext response message including N2 SM information to the AMF. For accepted PDU session, the N2 SM information includes CN tunnel information, updated parameters for the accepted QoS flows, optionally updated QoS profile(s) (e.g., taking the backup S-NSSAI into consideration). For failed PDU session, the N2 SM information includes corresponding failure cause. When the SMF decides to accept the slice replacement from the old S-NSSAI to the backup S-NSSAI for the PDU session, such PDU session is considered as accepted PDU session. Otherwise, such PDU session is considered as failed PDU session.

Referring to step 7-11, the AMF sends a N2 Path Switch Request Acknowledge message to the target NG-RAN. The message includes a list of PDU sessions for which resource has been successfully switched, with PDU session ID and corresponding N2 SM information for each PDU session. The corresponding N2 SM information includes CN tunnel information, updated parameters for the accepted QoS flows, optionally updated QoS profile(s). The message also includes a list of PDU sessions which have failed to be switched, with PDU session ID and corresponding N2 SM information for each PDU session. The corresponding N2 SM information includes the failure cause.

Referring to step 7-12, upon reception of the N2 path switch request acknowledge message from the AMF, the target NG-RAN sends a UE context release message to inform the source NG-RAN about the success of the handover and triggers the release of resources at the source NG-RAN node.

The present disclosure describes an exemplary embodiment for a network slice replacement during a home-routed roaming scenario.

For a home-routed PDU session, an AMF retrieves the mapped HPLMN S-NSSAI of a backup S-NSSAI from the NSSF or based on local configuration. The AMF determines whether the PDU session(s) that requires slice replacement can be forwarded to the corresponding visiting SMF (V-SMF) and home SMF (H-SMF).

When the PDU session can be forwarded, e.g., the serving S-NSSAI and the backup S-NSSAI can be supported by the same V-SMF and, the mapped HPLMN S-NSSAI of the serving S-NSSAI and the mapped HPLMN S-NSSAI of the backup S-NSSAI can be supported by the same H-SMF, the AMF forwards the N2 SM Information, the backup S-NSSAI and the mapped HPLMN S-NSSAI of the backup S-NSSAI to the corresponding V-SMF. The AMF stores the old S-NSSAI, the backup S-NSSAI, the mapped HPLMN S-NSSAI of the old S-NSSAI and the mapped HPLMN S-NSSAI of the backup S-NSSAI associated with the same PDU session identifier.

When the PDU session cannot be forwarded, e.g., the serving S-NSSAI and the backup S-NSSAI cannot be supported by the same V-SMF and/or the mapped HPLMN S-NSSAI of the serving S-NSSAI and the mapped HPLMN S-NSSAI of the backup S-NSSAI cannot be supported by the same H-SMF, the AMF informs the V-SMF to release such PDU Session and include such PDU Session in the failed PDU Session list returned to the NG-RAN.

When the V-SMF receives the backup S-NSSAI for the PDU session and V-SMF decides to accept replacement of the old S-NSSAI with the backup S-NSSAI, the V-SMF informs the H-SMF to update the PDU session with the mapped HPLMN S-NSSAI of the backup S-NSSAI. Otherwise the V-SMF informs the H-SMF to release such PDU session and include such PDU session in the failed PDU session list returned to the NG-RAN.

When the H-SMF receives the mapped HPLMN S-NSSAI of the backup S-NSSAI and H-SMF decides to accept the replacement, the H-SMF triggers replacement of the mapped HPLMN S-NSSAI of the old S-NSSAI with the mapped HPLMN S-NSSAI of the backup S-NSSAI for the PDU session. The H-SMF stores both the mapped HPLMN S-NSSAI of the old S-NSSAI and the mapped HPLMN S-NSSAI of the backup S-NSSAI associated with the same PDU session identifier. When the H-SMF cannot accept the replacement, the H-SMF includes such PDU session in the failed PDU session list returned to the NG-RAN and triggers the PDU session release procedure.

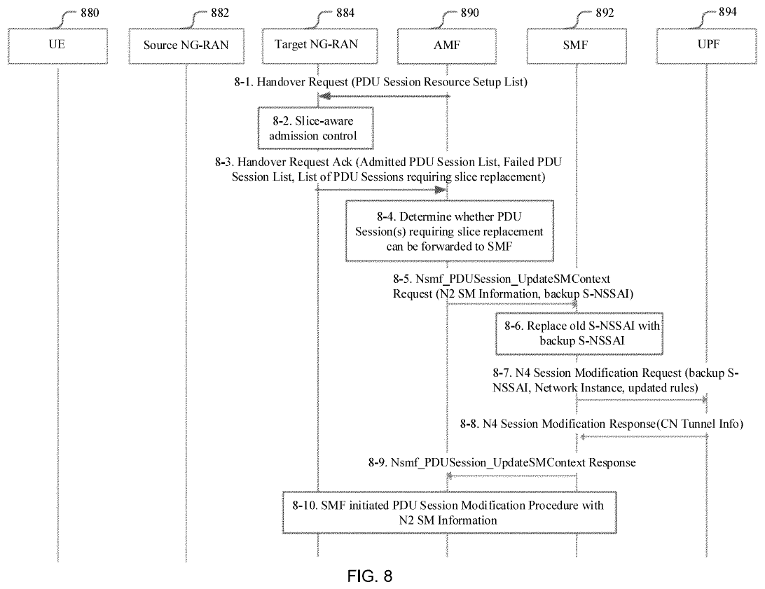

FIG. 8 shows a schematic diagram of an exemplary embodiment for a network slice replacement during a N2 based inter-NG-RAN handover procedure, including a portion or all of the following: a UE 880, a source NG-RAN 882, a target NG-RAN 884, an AMF 890, an SMF 892, and/or an UPF 894. During a N2 based inter NG-RAN handover procedure, when the PDU Session is associated with network slice which is congested at the target NG-RAN or the resource of the network slice is insufficient, a slice replacement may be realized, so that the network slice service continuity is guaranteed during UE mobility.

Referring to step 8-1, the AMF sends a handover request message including the N2 SM information to the target NG-RAN. The N2 SM information includes PDU session resource setup list, with a PDU session ID, a S-NSSAI, the N3 UP address, the UL CN tunnel ID of the UPF, the QoS parameters for each accepted PDU session.

Referring to step 8-2, a slice-aware admission control is performed by the target NG-RAN. The target NG-RAN fails to accept PDU session(s) established on one or more S-NSSAIs for the UE due to, e.g., the resource of the S-NSSAI(s) in the target NG-RAN node is insufficient or congested. Instead of rejecting such PDU session(s), the target NG-RAN selects a backup S-NSSAI from the allowed NSSAI, e.g., based on local configuration, to replace the old S-NSSAI with the selected backup S-NSSAI for PDU session(s) established on the old S-NSSAI. When a backup S-NSSAI is selected for the old S-NSSAI, the target NG-RAN accepts the PDU session(s) with slice replacement from old S-NSSAI to selected backup S-NSSAI.

Referring to step 8-3, the target NG-RAN sends a handover request acknowledge message to the AMF. The message includes a PDU session resource admitted list, with a PDU session ID and corresponding N2 SM information for each PDU session. The corresponding N2 SM information includes AN tunnel information. The message may also include a PDU session resource failed to setup list, with a PDU session ID and corresponding N2 SM information for each PDU session. The corresponding N2 SM information includes the failure cause.

The message may also include the accepted PDU session(s) with slice replacement in one of the following alternative methods.

In one method, the PDU Session(s) is included in the PDU session resource admitted list, with a PDU session ID, the backup S-NSSAI, and the corresponding N2 SM information for each of these PDU session. The corresponding N2 SM information includes AN tunnel information. In this method, the PDU session resource admitted list already exists, but it is expanded to include the backup S-NSSAI for the PDU session when available.

In another method, a list of PDU sessions that requires slice replacement is included in the message, with a PDU session ID, the backup S-NSSAI, and corresponding N2 SM information for each PDU session. The corresponding N2 SM information includes AN tunnel information, similar as the N2 SM information in PDU session resource admitted list. In this method, the list of PDU sessions that requires slice replacement is a newly defined information element.

In another method, the PDU Session(s) is included in the PDU session resource admitted list, with a PDU session ID, the backup S-NSSAI, and the corresponding N2 SM information for each of these PDU session. The corresponding N2 SM information includes AN tunnel information. The PDU session(s) is also included in the PDU session resource failed to setup list.

In another method, the list of PDU sessions that requires slice replacement is included in the message, with a PDU session ID, the backup S-NSSAI, and corresponding N2 SM information for each PDU session. The corresponding N2 SM information includes AN tunnel information, similar as the N2 SM information in the PDU session resource admitted list. The PDU session(s) is also included in the PDU session resource failed to setup list.

Referring to step 8-4, the AMF determines whether the PDU session(s) that requires slice replacement can be forwarded to the corresponding SMF. When the PDU session(s) that requires slice replacement can be forwarded, e.g., the old S-NSSAI and the backup S-NSSAI can be supported by the same SMF, the AMF forwards the N2 SM information and the backup S-NSSAI of the PDU session to the corresponding SMF. The AMF discards the items for such PDU sessions in the PDU session resource failed to setup list, when received. The AMF stores both the old S-NSSAI and the backup S-NSSAI associated with the same PDU session identifier.

When the PDU session(s) that requires slice replacement cannot be forwarded, e.g., the old S-NSSAI and the backup S-NSSAI cannot be supported by the same SMF, the AMF discards the items for such PDU sessions incorporated in the PDU session resource admitted list or the list of PDU sessions that requires slice replacement. When the PDU session resource failed to setup list includes the PDU session(s) that requires slice replacement, the AMF forwards the N2 SM information of the PDU session to the corresponding SMF. Otherwise the AMF informs the SMF to release such PDU session(s).

Referring to step 8-5, the AMF sends Nsmf_PDUSession_UpdateSMContext request message to the SMF. The message includes the N2 SM information and the backup S-NSSAI of the PDU session when received.

Referring to step 8-6, when the SMF receives the backup S-NSSAI for the PDU session and SMF decides to accept the replacement, the SMF triggers replacement of old S-NSSAI with the backup S-NSSAI for the PDU session. The SMF stores both the old S-NSSAI and the backup S-NSSAI associated with the same PDU session identifier. When the PDU session with backup S-NSSAI cannot be accepted, the SMF initiates PDU session release procedure.

Referring to step 8-7, the SMF may send a N4 session modification request message to the UPF. The message may include the backup S-NSSAI, the network instance (e.g., selected based on the backup S-NSSAI), the updated rules such as a packet detection rule (PDR) and a QoS enforcement rule (QER) (e.g., taking the backup S-NSSAI into consideration). The UPF may use the parameters, e.g., the backup S-NSSAI and the network instance, to determine internal UPF resources. Depending on the network deployment, the CN tunnel information of the UPF used for the old S-NSSAI and the backup S-NSSAI may be different. In this case, the SMF may ask the UPF to allocate new CN tunnel information.

When the UPF cannot support both the old S-NSSAI and the backup S-NSSAI, a new UPF supporting both S-NSSAIs may be selected. When the new UPF is selected, the SMF sends a N4 session establishment request message to the UPF with the similar parameters.

Referring to step 8-8, the UPF returns an N4 session modification/establishment response message to the SMF with updated CN tunnel information when it's available.

Referring to step 8-9, the SMF sends an Nsmf_PDUSession_UpdateSMContext response message to the AMF.

Referring to step 8-10, when the CN tunnel information and/or QoS profile(s) are updated (e.g., updated taking backup S-NSSAI into consideration), the SMF initiates PDU session modification procedure to update the target NG-RAN of updated CN tunnel information and/or updated QoS profile(s) after the handover procedure is complete.

The present disclosure describes another embodiment wherein the Home-routed roaming scenario described above may also apply in the above embodiments for a network slice replacement during a N2 based inter-NG-RAN handover procedure.

The present disclosure describes methods, apparatus, and computer-readable medium for wireless communication. The present disclosure addressed the issues with performing network slice replacement during user equipment (UE) mobility. The methods, devices, and computer-readable medium described in the present disclosure may facilitate the performance of wireless communication by performing network slice replacement during user equipment (UE) mobility, thus improving efficiency and overall performance. The methods, devices, and computer-readable medium described in the present disclosure may improve the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
receiving, by a radio-access network (RAN), a list of to-be-switched protocol data unit (PDU) sessions during a handover procedure;
selecting, by the RAN, a single-network slice selection assistant information (S-NSSAI) from a list of S-NSSAIs, the S-NSSAI corresponding to a PDU session in the list of to-be-switched PDU sessions; and
sending, by the RAN, a message to an access and mobility management function (AMF), the message comprising the PDU session in a list of PDU sessions that require slice replacement and the S-NSSAI associated with each PDU session.

2. The method according to claim 1, wherein:
the RAN receives the list of to-be-switched PDU sessions from one of a second RAN or the AMF.

3. The method according to claim 1, wherein:
the S-NSSAI is configured to replace a second S-NSSAI, the second S-NSSAI corresponding to the PDU session in the list of to-be-switched PDU sessions prior to the handover procedure.

4. The method according to claim 3, wherein:
the RAN selects the S-NSSAI from the list of S-NSSAIs; and
the list of S-NSSAIs comprises one or more S-NSSAI that is allowed to use for a user equipment (UE).

5. The method according to claim 3, wherein:
in response to the RAN's failure of accepting the PDU session in the list of to-be-switched PDU sessions associated with the second S-NSSAI, the RAN selects the S-NSSAI from the list of S-NSSAIs and replace the second S-NSSAI with the selected S-NSSAI for the PDU session.

6. The method according to claim 1, wherein:
the message comprises one of the following:
the list of to-be-switched PDU sessions comprising the list of PDU sessions that require slice replacement;
the list of PDU sessions that require slice replacement;
the list of to-be-switched PDU sessions comprising the list of PDU sessions that require slice replacement and a list of fail-to-establish PDU sessions comprising the list of PDU sessions that require slice replacement; or
the list of PDU sessions that require slice replacement and the list of fail-to-establish PDU sessions comprising the list of PDU sessions that require slice replacement.

7. The method according to claim 6, wherein:
for each PDU session in the list of PDU sessions that require slice replacement, the message comprises the corresponding S-NSSAI, a PDU session identifier (ID), and N2 session management (SM) information corresponding to the each PDU session; and
the N2 SM information comprises access network (AN) tunnel information.

8. The method according to claim 3, further comprising:
receiving, by the RAN, an updated core network (CN) tunnel information or an updated quality of service (QoS) profile for one or more PDU sessions in the list of PDU sessions that require slice replacement.

9. A method for wireless communication, comprising:
receiving, by an access and mobility management function (AMF), a message from a radio-access network (RAN), the message comprising a protocol data unit (PDU) session in a list of PDU sessions that require slice replacement with a corresponding single-network slice selection assistant information (S-NSSAI) for each PDU session;
determining, by the AMF, whether to accept the PDU session in the list of PDU sessions that require slice replacement with the corresponding S-NSSAI;
in response to determining to accept the PDU session with the S-NSSAI, sending, by the AMF, the S-NSSAI corresponding to the PDU session to a corresponding session management function (SMF).

10. The method according to claim 9, wherein:
the S-NSSAI is configured to replace a second S-NSSAI, the second S-NSSAI corresponding to the PDU session that requires slice replacement prior to a handover procedure.

11. The method according to claim 10, wherein the determining whether to accept the PDU session in the list of PDU sessions that require slice replacement with the S-NSSAI comprises:
determining, by the AMF, whether the S-NSSAI and the second S-NSSAI are supported by a same SMF;
in response to determining that the S-NSSAI and the second S-NSSAI are supported by the same SMF, determining, by the AMF, to accept the PDU session; or
in response to determining that the S-NSSAI and the second S-NSSAI are not supported by the same SMF, determining, by the AMF, not to accept the PDU session.

12. The method according to claim 11, further comprising:
in response to determining to accept the PDU session:
sending, by the AMF, corresponding N2 SM information and the corresponding S-NSSAI to the corresponding SMF,
in response to receiving the PDU session in a list of fail-to-establish PDU sessions, discarding, by the AMF, the PDU session in the list of fail-to-establish PDU sessions, and
storing, by the AMF, the S-NSSAI and the second S-NSSAI corresponding to a same PDU session identifier.

13. The method according to claim 11, further comprising:
in response to determining not to accept the PDU session:
discarding, by the AMF, the PDU session in a list of to-be-switched PDU sessions or the list of PDU sessions that require slice replacement,
in response to receiving the PDU session in a list of fail-to-establish PDU sessions, sending, by the AMF, corresponding N2 SM information to the corresponding SMF, or
in response to receiving the list of fail-to-establish PDU sessions not comprising the PDU session, sending, by the AMF, information to release the PDU session to the corresponding SMF and include the PDU session in the list of fail-to-establish PDU sessions.

14. A method for wireless communication, comprising:
receiving, by a session management function (SMF), a single-network slice selection assistant information (S-NSSAI) corresponding to a protocol data unit (PDU) session in a list of PDU sessions that require slice replacement from an access and mobility management function (AMF);
determining, by the SMF, whether to accept the PDU session with the S-NSSAI;
in response to determining to accept the PDU session:
triggering, by the SMF, replacement of a second S-NSSAI with the S-NSSAI for the PDU session, and
storing, by the SMF, the S-NSSAI and the second S-NSSAI associated with a same PDU session identifier,
in response to determining not to accept the PDU session:
triggering, by the SMF, a PDU session release procedure; and
sending, by the SMF, a N4 message to a user plane function (UPF), the N4 message comprising at least one of the following: the S-NSSAI, a network instance, or an updated rule.

15. The method according to claim 14, wherein:
the S-NSSAI is configured to replace the second S-NSSAI, the second S-NSSAI corresponding to the PDU session prior to a handover procedure.

16. The method according to claim 14, further comprising:
receiving, by the SMF, CN tunnel information from the UPF;
in response to the core network (CN) tunnel information or a QoS profile being updated, sending, by the SMF, the updated CN tunnel information or the updated quality of service (QoS) profile to a radio-access network (RAN).

17. (canceled)

18. (canceled)

19. A wireless communications apparatus comprising a processor and a memory, wherein the processor is configured to read code from the memory and implement the method recited in claim 1.

20. A computer program product comprising a computer-readable program medium code stored thereupon, the computer-readable program medium code, when executed by a processor, causing the processor to implement the method recited in claim 1.

21. A wireless communications apparatus comprising a processor and a memory, wherein the processor is configured to read code from the memory and implement the method recited in claim 9.

22. A wireless communications apparatus comprising a processor and a memory, wherein the processor is configured to read code from the memory and implement the method recited in claim 14.
